(19) United States
(12) Patent Application Publication
(10) Pub. No.: US 2025/0242422 A1
(43) Pub. Date: Jul. 31, 2025

(54) ANALYSIS OF THE GEAR CUTTING PROCESS BY MEANS OF A ROLLING TEST

(71) Applicant: Klingelnberg AG, Zürich (CH)

(72) Inventor: Alexander Landvogt, Rockenberg (DE)

(21) Appl. No.: 19/034,115

(22) Filed: Jan. 22, 2025

(30) Foreign Application Priority Data
Jan. 25, 2024 (EP) 24154040.0

(51) Int. Cl. B23F 1/06; G01M 13/021

(52) U.S. Cl. CPC B23F 1/06; G01M 13/021

(57) ABSTRACT

A gear cutting method includes: machining of a gearing of a component by a gear cutting machine, wherein during the machining, axis data of at least one machine axis of the machine, are recorded and/or wherein sensor data of a sensor of the machine, are recorded during the machining; providing the recorded axis data in relation to one revolution of the component as rotation-related axis data and/or providing the recorded sensor data in relation to one revolution as rotation-related sensor data; rolling test of the toothed component by a rolling test bench, wherein measurement data of the test are provided in relation to one revolution during the test as rotation-related measurement data; comparing the axis and/or sensor data with measurement data of the test to determine correlations between gear deviations according to measurement data of the test and machine deviations according to the axis and/or sensor data.

### CROSS-REFERENCE TO RELATED APPLICATIONS

This application claims the benefit of European patent application no. 24154040.0, filed on 25 Jan. 2024, the disclosure of which is incorporated herein by reference in its entirety.

### TECHNICAL FIELD

The present disclosure relates to a method comprising the following method steps: Machining of a gearing of a component by means of a gear cutting machine and rolling test of the toothed component by means of a rolling test bench.

### BACKGROUND

Due to the ever-increasing demands on the quality of gears and in particular their noise behavior, up to 100% of all manufactured gears in industrial series production are subjected to a rolling test on a rolling test bench. Among other things, periodic deviations that have a negative effect on the noise behavior of a gear can be determined here.

It is also known to record axis data or sensor data from the respective gear cutting machine during the machining of a gear in order to monitor the machine functions, the machine components and the manufacturing process itself. Such machine tool data is usually recorded as displacement or time signals.

Deviations, e.g. of the axes or drives or the kinematics of the gear cutting machine, may be reflected in the results of the rolling test, as the deviations are partly transferred to the geometry of the manufactured gearing. The results of a rolling test are usually recorded in relation to the component rotation during the rolling test. The results of the rolling test are not directly comparable with the data from an analysis of the gear cutting machine, making it difficult to determine correlations between the results of the rolling test and the data from the machine analysis.

### SUMMARY

Against this background, the present disclosure is based on the technical problem of specifying a method that enables an efficient comparison between the results of the rolling test and data from an analysis of the gear cutting machine.

The technical problem described above is solved with the features of independent claims. Further designs of the disclosure result from the dependent claims and the following description.

According to a first aspect, the disclosure relates to methods comprising the method steps of: machining a gearing of a component by means of a gear cutting machine, wherein during the machining of the gearing, axis data of at least one machine axis of the gear cutting machine, such as an axis feed, an axis acceleration, a power consumption of an axis drive or the like, are recorded and/or wherein sensor data of at least one sensor of the gear cutting machine, such as a structure-borne sound sensor, an acceleration sensor, a distance sensor or the like, are recorded during the machining of the gearing; providing the recorded axis data in relation to one revolution of the component as rotation-related axis data and/or providing the recorded sensor data in relation to one revolution of the component as rotation-related sensor data; rolling test of the toothed component by means of a rolling test bench, wherein measurement data of the rolling test are provided as rotation-related measurement data in relation to one revolution of the component during the rolling test; comparing the rotation-related axis data and/or the rotation-related sensor data with the rotation-related measurement data of the rolling test in order to determine correlations between gear deviations according to the rotation-related measurement data of the rolling test and machine deviations according to the rotation-related axis data and/or the rotation-related sensor data.

The fact that both the measurement data of the rolling test and the axis data and/or sensor data of the gear cutting machine are specified in relation to the rotation, i.e. in relation to a respective component rotation, means that correlations can be searched for directly. In this way, errors or defects in the gear cutting machine, such as faulty axles, drives, bearings or the like, can be inferred directly from deviations measured during the rolling test.

The specification of the axis data and/or sensor data of the gear cutting machine as data related to a component rotation enables, for example, a simplified comparison with the measurement data of the rolling test compared to the pure time reference of this data known in the prior art.

According to one design of the method, it may be provided that the rotation-related axis data is provided as an order spectrum, in particular by means of FFT. The abbreviation FFT stands for the fast Fourier transformation in a known manner. The orders are multiples of the rotational speed of the component, so that measured deviations or measured values are plotted as amplitudes over the individual orders.

According to one design of the method, it may be provided that the rotation-related sensor data is provided as an order spectrum, in particular by means of FFT. The abbreviation FFT stands for the fast Fourier transformation in a known manner. The orders are multiples of the rotational speed of the component, so that measured deviations or measured values are plotted as amplitudes over the individual orders.

It may be provided that the rotation-related results of the rolling test are provided as an order spectrum, in particular by means of FFT. The abbreviation FFT stands for the fast Fourier transformation in a known manner. The orders are multiples of the rotational speed of the component, so that measured deviations or measured values are plotted as amplitudes over the individual orders.

Orders of the rolling test can be compared directly with orders of the axis data and/or sensor data of the gear cutting machine. If, for example, anomalies occur for the order spectrum of the rolling test and for the order spectrum of the axis data, e.g. of the second or ninth order, it can be assumed that there is a direct correlation between the deviation of the axis data and the deviation of the rolling test. If a component of the gear cutting machine can be specifically assigned to the corresponding order of the axis data, the error in the gearing can be reduced or eliminated for subsequent gearings to be manufactured by calibrating and/or maintaining the component in question.

For example, it may be provided that a first component of the gear cutting machine, such as a bearing, a drive or the like, is assigned at least one order of one of the order spectra and that a second component of the gear cutting machine, such as a bearing, a drive or the like, which is different from the first component, is assigned at least one further order of one of the order spectra, wherein a defect in the first component and/or the second component is detected on the basis of an amplitude of one of the orders.

Components of the gear cutting machine are excited to vibrate during the machining of the gearing, in particular in the range of their natural frequencies, wherein the vibration excitation is caused, for example, by periodically occurring machining forces and/or by traversing movements, i.e. movements and in particular accelerations of the controlled machine axes. Vibrations frequently occur which are multiples of a tooth meshing frequency, a tool spindle speed and/or a workpiece spindle speed. With the approach according to the disclosure, all recorded vibrations are now specified in relation to the workpiece or component rotation in order to enable a direct comparison with the results of the rolling test.

It may be provided that the axis data and/or sensor data are already recorded or stored as data related to the component rotation during their recording. Alternatively, it may be provided that axis data and/or sensor data are recorded or stored with, for example, a time reference or in relation to a tool rotation and then transformed as data related to the component rotation. In particular, the transformation can be automated and computer-aided. The transformation can take place after averaging the data.

According to one design of the method, it may be provided that an averaging of axis data takes place, in particular an averaging per component revolution. Alternatively or additionally, it may be provided that an averaging of sensor data takes place, in particular an averaging per component revolution.

An acceleration sensor can be provided as a sensor for recording sensor data, which is assigned to a workpiece spindle of the gear cutting machine, wherein the rotational positions of the workpiece spindle are recorded at the same time as the sensor data of the acceleration sensor is recorded. The rotational positions are angular positions of the workpiece spindle that carries the component during machining. By simultaneously recording the rotational positions of the workpiece spindle, the sensor data of the acceleration sensor can be stored as data related to the workpiece spindle rotation. The measured values of the acceleration sensor can be averaged for each workpiece spindle revolution.

According to one design of the method, it may be provided that a current consumption of a tool spindle, e.g. a grinding spindle, is recorded as axis data. Again, while the current consumption of the tool spindle is being recorded, the rotational positions of the workpiece spindle can be recorded at the same time in order to record the current consumption in relation to one workpiece spindle revolution. The measured values of the current consumption can be averaged for each workpiece spindle revolution. In particular, periodic fluctuations in the current consumption of the workpiece spindle can be correlated with measured deviations in the rolling test.

### BRIEF DESCRIPTION OF THE DRAWINGS

The disclosure is described in more detail below with reference to a drawing illustrating exemplary embodiments, which show schematically in each case:

FIG. 1 shows a gear grinding machine;

FIG. 2 shows a grinding spindle with a toothed component to be ground;

FIG. 3 shows a test bench for single flank rolling test;

FIG. 4 shows a result of a rolling test;

FIG. 5 shows a test bench for double flank rolling test;

FIG. 6 shows order spectra of the rolling test, axis data and sensor data; and

FIG. 7 shows a flow chart of a method according to the disclosure.

### DETAILED DESCRIPTION OF THE DRAWINGS

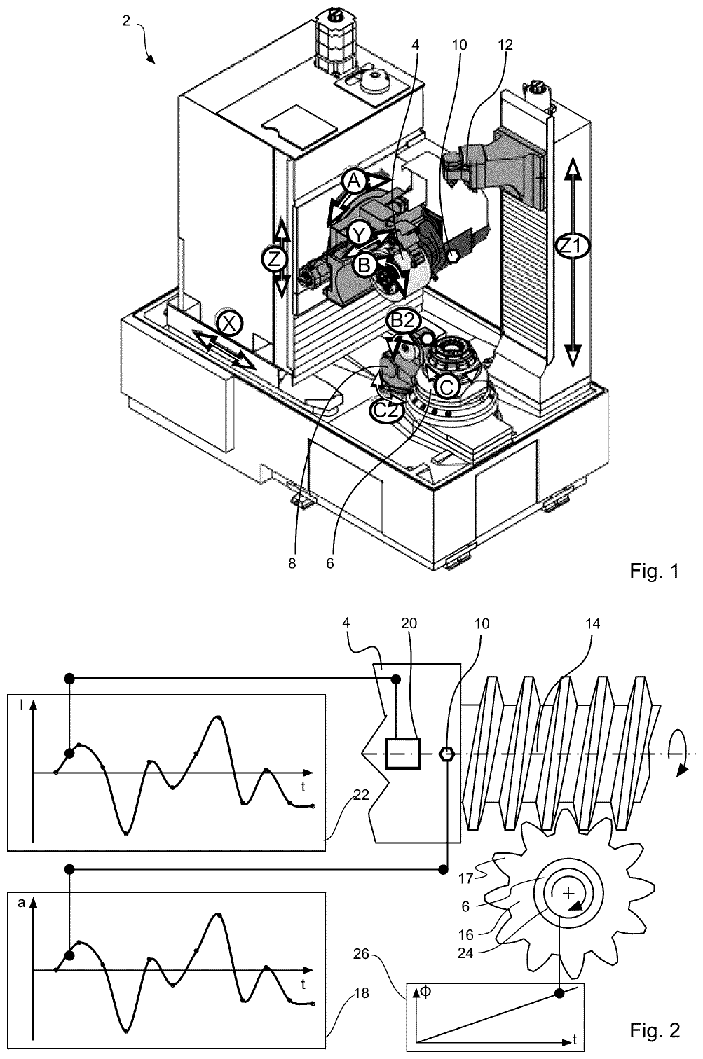

FIG. 1 shows a gear grinding machine, specifically a gear grinding machine 2. The gear grinding machine 2 has a tool spindle 4 for holding and rotating a grinding tool. The gear grinding machine 2 has a workpiece spindle 6 for holding and rotating a toothed component to be ground. The gear grinding machine has a dressing device 8 for dressing grinding tools.

The tool spindle 4, which can also be referred to as a grinding tool spindle, is assigned an acceleration sensor 14 for recording sensor data.

The gear grinding machine 2 has numerically controlled machine axes X, Y, Z, A, B, C, C2, B2 for executing translational and rotational relative movements in order to provide the required machining kinematics during gear cutting or dressing. Furthermore, the gear grinding machine 2 has an axis Z1 with a movable quill 12 for clamping shafts or mandrels.

FIG. 2 shows a schematic example of the tool spindle 4 with a dressable grinding worm 14 held on it and the workpiece spindle 6 with a toothed component 16 to be ground held on it, the gearing 17 of which is ground.

During the grinding process, sensor data 18 of the acceleration sensor 10 is recorded as a time signal of an acceleration a over the time t. Furthermore, axis data 22 in the form of a current consumption I of a motor 20 for rotating the workpiece spindle 4 is recorded as a time signal of a current consumption I over the time t during the grinding process. The curves shown schematically are not real measurement data and are merely to be understood as placeholders.

In addition, at the same time as the sensor data 18 and axis data 22, angular positions of the workpiece spindle 6 are recorded as further axis data 26 by means of a rotary encoder 24 during the grinding process, specifically as a rotation angle φ over the time t.

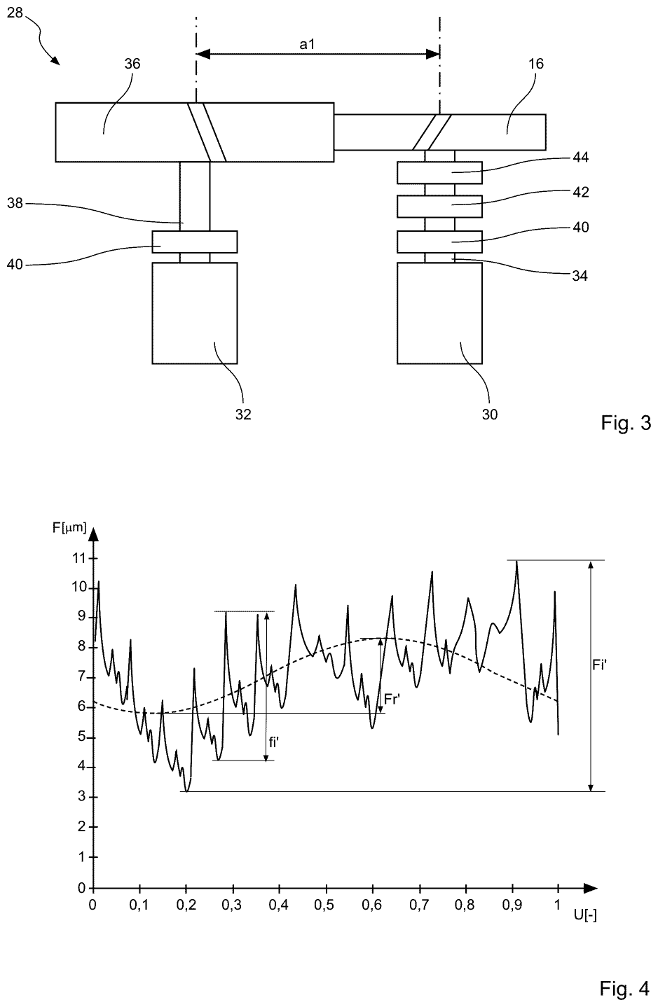

FIG. 3 shows an example of the schematic structure of a test bench 28 for carrying out a single flank rolling test for a respective toothed component 16.

The test bench 28 has a first drive 30 and a second drive 32. The first drive 30 is set up to drive a first shaft 34, on which the toothed component 16 to be tested is mounted.

The second drive 32 is used to brake a mating gear 36, which is mounted on a second shaft 26 coupled to the drive 20.

The mating gear 36 is an externally toothed spur gear that meshes with the gearing of the component 16. By driving the toothed component 16 and simultaneously braking the mating gear 36, a speed and a torque can be set during the test run. It is understood that speed and torque curves can also be adjusted. A center distance a1 between the shafts 38, 34 is constant.

The test bench 16 has rotary encoders or angle measuring systems 40, a rotational acceleration sensor 42 and a structure-borne sound sensor 44.

FIG. 4 shows a schematic example of the measured rotational error F in [μm] plotted over one revolution U of the gearwheel 16, i.e. a result of the single flank rolling test of a single toothed component 16. From this, values for the first-order concentricity error Fr′, the tooth-to-tooth amplitude fi′ and the maximum rolling deviation Fi′, for example, can be determined in a known manner.

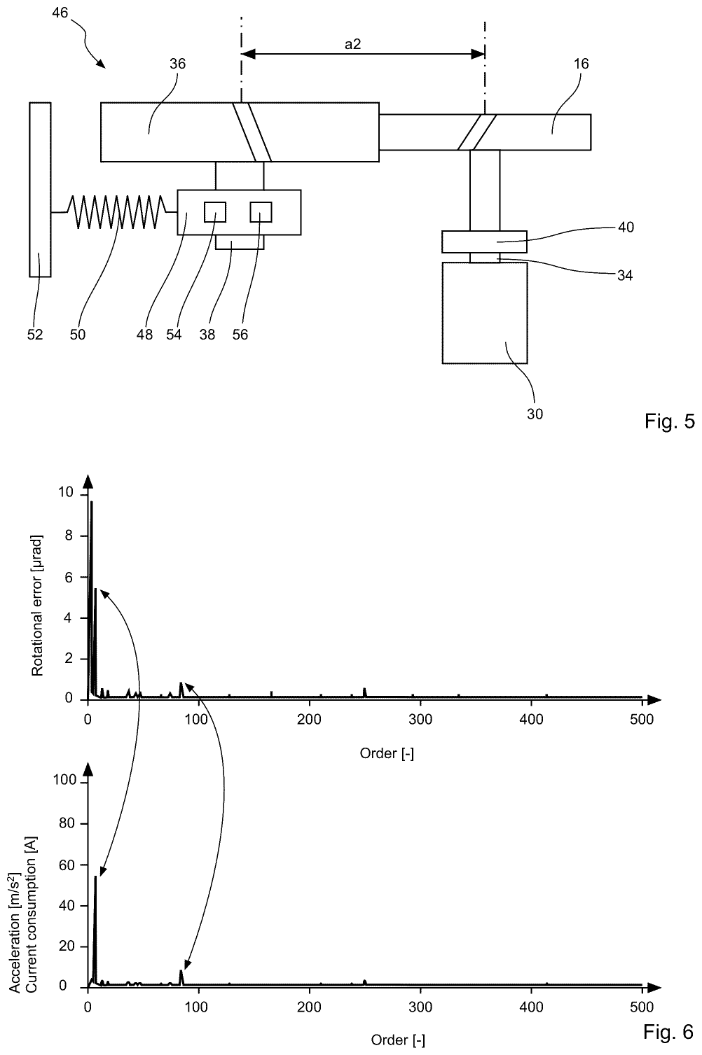

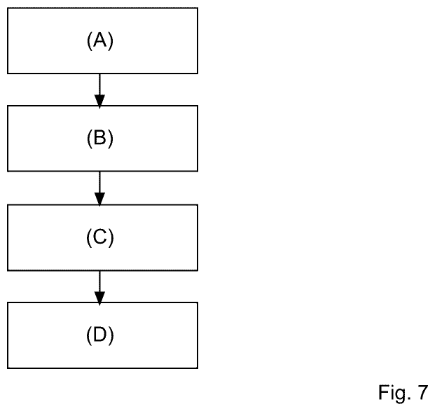

Alternatively or additionally, a double flank rolling test can be carried out. A test bench 46 for the double flank rolling test is shown schematically as an example in FIG. 5. To avoid repetition, the same reference signs are assigned to the same features below.

The double flank rolling test differs essentially from the single flank rolling test described above with reference to FIG. 3 in that a center distance a2 is not constant during the test. The mating gear 36 is mounted and supported with its shaft 38 on a movable carriage 48. The movable carriage 48 is supported by means of a spring device 50 on an immovable counterholder 52.

By means of the spring device 50, the mating gear 36 is pressed into tooth contact with the gearing of the component 16 to be tested, with both the right-hand and left-hand flanks of the gearing of the component 16 to be tested making contact on both sides of the tooth contact.

During the test, i.e. during the rolling of the toothed component 16 with the mating gear 36, the mating gear 36 is pressed in the direction of the component 16 with a defined force.

The deviation is recorded by means of a translational displacement of the movable carriage 34, wherein a displacement sensor 54 and a vibration sensor 56 are assigned to the carriage 48 in order to record measurement data. The results of the double flank rolling test are, for example, the rolling concentricity deviation, the double flank rolling deviation and the double flank rolling jump.

The upper part of FIG. 6 shows a schematic example of an order spectrum determined from the measured rotational error according to FIG. 4. Again, it should be noted that these are only schematic representations and not real measured values. The orders correspond to multiples of the rotational speed of the component during the rolling test.

The lower part of FIG. 6 shows a schematic example of an order spectrum that has been generated from the axis data or sensor data as shown in FIG. 3. Accordingly, the y-axis in the exemplary illustration is labeled both “acceleration” and “current consumption”.

By comparing the dominant order, errors or deviations of the gear cutting machine can be assigned to measured deviations of the toothed component. For example, it can be recognized that bearing damage or bearing wear of the tool spindle of the gear cutting machine leads directly to a measurable rotational error, e.g. of the second order of the toothed component. The fact that both the results of the rolling test and the axis data and/or measurement data are each given in relation to the component rotation means that correlations between gear deviations and machine deviations can be easily and directly identified.

A method according to the disclosure can therefore be specified, having the method steps of:
(A) Machining of the gearing of a component 16 by means of the gear cutting machine 2, wherein axis data 22, 26 of the machine axes 4 and 6 of the gear cutting machine 2 are recorded during the machining of the gearing and wherein sensor data 18 of at least the sensor 10 of the gear cutting machine 2 are recorded during the machining of the gearing;
(B) providing the recorded axis data 22, 26 related to one revolution of the component 16 as rotation-related axis data 22, 26 and providing the recorded sensor data 18 related to one revolution of the component 16 as rotation-related sensor data, wherein the rotation-related axis data is provided as an order spectrum using FFT and the rotation-related sensor data is provided as an order spectrum using FFT;
(C) Rolling test of the toothed component by means of a rolling test bench, wherein measurement data of the rolling test are provided in relation to one revolution of the component during the rolling test as rotation-related measurement data, wherein the rotation-related results of the rolling test are provided by means of FFT as an order spectrum;
(D) Comparison of the rotation-related axis data and the rotation-related sensor data with the rotation-related measurement data of the rolling test in order to determine correlations between gear deviations according to the rotation-related measurement data of the rolling test and machine deviations according to the rotation-related axis data and the rotation-related sensor data.

1. A method including the following steps:
machining of a gearing of a component by a gear cutting machine, wherein during the machining of the gearing, axis data of at least one machine axis of the gear cutting machine, are recorded and/or wherein sensor data of at least one sensor of the gear cutting machine, are recorded during the machining of the gearing;
providing the recorded axis data in relation to one revolution of the component as rotation-related axis data and/or providing the recorded sensor data in relation to one revolution of the component as rotation-related sensor data;
rolling test of the toothed component by a rolling test bench, wherein measurement data of the rolling test are provided in relation to one revolution of the component during the rolling test as rotation-related measurement data; and
comparing the rotation-related axis data and/or the rotation-related sensor data with the rotation-related measurement data of the rolling test to determine correlations between gear deviations according to the rotation-related measurement data of the rolling test and machine deviations according to the rotation-related axis data and/or the rotation-related sensor data.

2. The method according to claim 1,
wherein the rotation-related axis data is provided as an order spectrum, by FFT and/or the rotation-related sensor data is provided as an order spectrum.

3. The method according to claim 1,
wherein the rotation-related results of the rolling test are provided as an order spectrum, by FFT.

4. The method according to claim 2,
wherein a first component of the gear cutting machine, is assigned at least one order of one of the order spectra, and in that a second component of the gear cutting machine, which is different from the first component, is assigned at least one further order of one of the order spectra, wherein a defect in the first component and/or the second component is detected on the basis of an amplitude of one of the orders.

5. The method according to claim 1,
wherein an averaging of the axis data takes place, wherein an averaging per component revolution takes place and/or an averaging of the sensor data takes place.

6. The method according to claim 1,
wherein an acceleration sensor is provided as sensor for recording sensor, which is assigned to a tool spindle of the gear cutting machine, wherein the rotational positions of the workpiece spindle are recorded simultaneously with the recording of sensor data of the acceleration sensor.

7. The method according to claim 1,
wherein a current consumption of a tool spindle is recorded as axis data, wherein the rotational positions of the workpiece spindle are recorded at the same time as the current consumption of the tool spindle is recorded.
